(19) United States
(12) Patent Application Publication
(10) Pub. No.: US 2026/0073894 A1
(43) Pub. Date: Mar. 12, 2026

(54) KEYBOARD WEIGHT OF KEYBOARD INSTRUMENT, KEY ATTACHED WITH KEYBOARD WEIGHT, AND METHOD OF ATTACHING KEYBOARD WEIGHT

(71) Applicant: KABUSHIKI KAISHA KAWAI GAKKI SEISAKUSHO, Hamamatsu-shi, Shizuoka-ken (JP)

(72) Inventor: Kousuke TANAKA, Hamamatsu-shi (JP)

(21) Appl. No.: 19/319,524

(22) Filed: Sep. 4, 2025

(30) Foreign Application Priority Data
Sep. 11, 2024 (JP) 2024-157839

(51) Int. Cl. G10C 3/12

(52) U.S. Cl. CPC G10C 3/12

(57) ABSTRACT

A keyboard weight includes: a weight main body that is made of a material other than lead and is formed in a columnar shape having a predetermined diameter and a predetermined length; and a hollow member that is made of a material other than lead, is formed in a cylindrical shape having an inner diameter allowing the weight main body to be inserted into the hollow member, an outer diameter allowing the hollow member to be inserted into the embedding hole, and a predetermined length, and is inserted into the embedding hole in a state where the weight main body is inserted inside when the keyboard weight is attached to the key. The hollow member is provided with a thin portion that extends along an entire circumferential direction, has a predetermined width in a length direction, and has a thickness smaller than a thickness of the other portion of the hollow member. The hollow member is configured such that when the keyboard weight is attached to the key, the hollow member is pressed from both sides in the length direction, whereby buckling occurs starting from the thin portion.

### BACKGROUND

### Technical Field

The present invention is applied to a keyboard device of a keyboard instrument such as an acoustic piano, and relates to a keyboard weight attached to a key in order to obtain a desired touch weight at the time of key pressing, a key attached with the keyboard weight, and a method of attaching a keyboard weight.

### Related Art

Conventionally, in an acoustic piano such as a grand piano, a weight is generally attached to a key in order to obtain a desired touch weight at the time of key pressing. As such a keyboard weight, lead is used from the viewpoints of high specific gravity, low cost, ease of processing, and the like. An embedding hole penetrating the key in a left-right direction is provided at a predetermined position of a front portion of the key extending in a front-rear direction, and the keyboard weight is attached to the key by being pressed and caulked from the left and right using a caulking machine in a state where the keyboard weight is inserted into the embedding hole.

Since lead used as the keyboard weight is a harmful substance, it is desirable not to use lead as much as possible as the keyboard weight. The present applicant has proposed various keyboard weights made of an alternative material instead of lead, and for example, those described in JP 2003-122344 A are known.

The keyboard weight described in JP 2003-122344 A includes a columnar weight and a cylindrical member into which the weight can be inserted. The weight is made of a relatively heavy material other than lead, for example, iron, copper, brass, an alloy, a composite material of a metal and a synthetic resin, or the like. On the other hand, the cylindrical member has a thin cylindrical shape with both ends opened, and has an outer diameter slightly smaller than a diameter of the embedding hole formed in the key. Further, the cylindrical member is made of a material that is relatively easily deformed other than lead, for example, a metal such as aluminum, plastic, or an elastic material such as rubber. Furthermore, the cylindrical member is provided with a slit extending over an entire length direction of the cylindrical member.

In a case where the keyboard weight configured as described above is attached to the embedding hole of the key, first, the cylindrical member is inserted into the embedding hole. Next, in a state where a distal end portion of the weight is inserted into the cylindrical member, the weight is driven by a hammer or the like and press-fitted into the cylindrical member. Consequently, the cylindrical member is pushed and expanded outward in a radial direction by the press-fitted weight and is brought into pressure contact with a wall surface of the embedding hole. As a result, the weight is firmly fixed to the key via the cylindrical member.

### Citation List

### Patent Literature

Patent Literature 1: JP 2003-122344 A

### SUMMARY

In a case where the conventional keyboard weight described above is attached to the key, the weight is driven by the hammer in a state where the distal end portion of the weight is inserted into the cylindrical member inserted into the embedding hole of the key, so that the entire outer peripheral surface of the cylindrical member expands outward in the radial direction. In this case, when the weight is driven at once with a relatively large force, cracks may occur around the embedding hole of the key due to rapid expansion to the outside in the radial direction of the cylindrical member. In addition, by driving the weight little by little with a relatively small force, it is possible to suppress the occurrence of the cracks described above, but in this case, it takes time to attach the weight to the key, and manufacturing efficiency of the key is lowered.

The present invention has been made to solve the above problems, and it is an object thereof to provide a keyboard weight that can be easily manufactured using an alternative material instead of lead and can be easily attached to a key, a key attached with the keyboard weight, and a method of attaching the keyboard weight.

In order to achieve the above object, according to an invention according to a first aspect, there is provided a keyboard weight immovably attached in an inserted state to a penetrating embedding hole having a predetermined diameter formed in a key of a keyboard instrument, the keyboard weight including: a weight main body that is made of a material other than lead and is formed in a columnar shape having a predetermined diameter and a predetermined length; and a hollow member that is made of a material other than lead, is formed in a cylindrical shape having an inner diameter allowing the weight main body to be inserted into the hollow member, an outer diameter allowing the hollow member to be inserted into the embedding hole, and a predetermined length longer than the weight main body, and is inserted into the embedding hole in a state where the weight main body is inserted inside when the keyboard weight is attached to the key, wherein the hollow member is provided with a thin portion that extends along an entire circumferential direction, has a predetermined width in a length direction, and has a predetermined thickness smaller than a thickness of the other portion of the hollow member, and the hollow member is configured such that when the keyboard weight is attached to the key, the hollow member is pressed from both sides in the length direction, whereby buckling occurs starting from the thin portion.

According to this configuration, the keyboard weight attached to the embedding hole of the key includes the columnar weight main body made of a material other than lead and the cylindrical hollow member. In addition, the hollow member is provided with the thin portion that extends along the entire circumferential direction, has the predetermined width in the length direction, and has the predetermined thickness smaller than the thickness of the other portion. In a case where the keyboard weight is attached in a state of being inserted into the embedding hole of the key, the hollow member is pressed from both sides in the length direction, whereby buckling occurs starting from the thin portion in the hollow member. As a result, in the hollow member, a peripheral portion (hereinafter, referred to as a “deformed portion” in this field) including the thin portion is deformed inward and outward in the radial direction of the hollow member. Therefore, the deformed portion deformed outward in the radial direction bites into a wall surface of the embedding hole of the key or is strongly pressed, while the deformed portion deformed inward in the radial direction bites into an outer peripheral surface of the weight main body or is strongly pressed. As a result, the keyboard weight is firmly attached to the embedding hole of the key.

Since the weight main body of the keyboard weight is formed in a columnar shape, for example, the weight main body can be easily obtained by cutting a long round bar having the same diameter as the weight main body at the same length as the weight main body. Further, since the hollow member of the keyboard weight is formed in a cylindrical shape, for example, a long cylindrical tube having the same outer shape and thickness as the hollow member is cut at the same length as the hollow member, and the thin portion is provided in each long cylindrical tube, whereby the hollow member can be easily obtained. Furthermore, as described above, in a case where the keyboard weight is attached to the key, the keyboard weight inserted into the embedding hole of the key may be pressed from both sides in the length direction, so that the keyboard weight can be attached using a conventional caulking machine. As described above, according to the present invention, it is possible to obtain a keyboard weight that can be easily manufactured and can be easily attached to a key while using an alternative material instead of lead.

According to an invention according to a second aspect, in the keyboard weight according to the first aspect, the thin portion is formed by providing a groove that is located at a center in a length direction of the hollow member and is opened outward in a radial direction.

According to this configuration, the thin portion can be easily formed by forming the groove opened outward in the radial direction at the center in the length direction of the outer peripheral surface of the cylindrical member having no thin portion by cutting or the like.

According to an invention according to a third aspect, in the keyboard weight according to the second aspect, both end portions of the hollow member into which the weight main body is inserted are provided with locking portions that are formed so as to protrude inward in the radial direction and lock the weight main body immovably in the length direction of the hollow member.

According to this configuration, the weight main body is immovably locked in the length direction of the hollow member by the locking portions provided at both end portions of the hollow member into which the weight main body is inserted. Therefore, when the keyboard weight is pressed and attached from both sides in the length direction of the hollow member in a state where the keyboard weight is inserted into the embedding hole of the key, the weight main body can be stably attached without shifting in the length direction of the hollow member.

According to an invention according to a fourth aspect, there is provided a key including: a key main body that is made of wood, extends in a front-rear direction, and is configured to be swingable, the key main body being provided with an embedding hole penetrating the key main body in a left-right direction at a predetermined position in the front-rear direction; and a keyboard weight that is attached by being pressed from both left and right sides of the key main body in a state of being inserted into the embedding hole of the key main body, wherein the keyboard weight includes the keyboard weight according to the first aspect.

According to this configuration, since the keyboard weight according to the first aspect is attached to the key by being pressed from both left and right sides of the key main body in a state of being inserted into the embedding hole of the key main body, it is possible to obtain a key to which the keyboard weight having the functions and effects of the first aspect described above is attached.

According to an invention according to a fifth aspect, there is provided a method of attaching a keyboard weight, including: a weight component preparation step of preparing the weight main body and the hollow member according to the first aspect; a key preparation step of preparing a key provided with the embedding hole according to the first aspect; a keyboard weight manufacturing step of manufacturing the keyboard weight by inserting the weight main body into the hollow member; a keyboard weight insertion step of inserting the manufactured keyboard weight into the embedding hole of the key; and a keyboard weight attachment step of attaching the keyboard weight in a state of being fixed to the embedding hole of the key by causing buckling starting from the thin portion by pressing the keyboard weight from both sides in a length direction.

According to this configuration, first, the weight main body and the hollow member according to the first aspect and the key provided with the embedding hole according to the first aspect are prepared (weight component preparation step and key preparation step). Next, the keyboard weight is manufactured by inserting the weight main body into the hollow member (keyboard weight manufacturing step), and the manufactured keyboard weight is inserted into the embedding hole of the key (keyboard weight insertion step). The keyboard weight is attached in a state of being fixed to the embedding hole of the key by causing buckling starting from the thin portion of the hollow member by pressing the keyboard weight from both sides in the length direction (keyboard weight attachment step). As described above, by causing buckling starting from the thin portion of the hollow member, the deformed portion bites into the wall surface of the embedding hole of the key or is strongly pressed, and bites into the outer peripheral surface of the weight main body or is strongly pressed. As a result, the keyboard weight is firmly attached to the embedding hole of the key. As described above, according to the present invention, the keyboard weight made of an alternative material instead of lead can be easily and firmly attached to the embedding hole of the key.

According to an invention according to a sixth aspect, in the method according to the fifth aspect, in the keyboard weight manufacturing step, both end portions of the hollow member are pressed from both sides in a state where the weight main body is inserted into the hollow member to deform so as to protrude inward in a radial direction, and locking portions for locking the weight main body immovably in the length direction of the hollow member are formed.

According to this configuration, in the keyboard weight manufacturing step, the locking portions are formed by pressing both end portions of the hollow member from both sides in a state where the weight main body is inserted into the hollow member. As a result, it is possible to relatively easily form the locking portions for locking the weight main body inserted into the hollow member immovably in the length direction of the hollow member. Further, when the keyboard weight having the locking portions is pressed and attached from both sides in the length direction of the hollow member in a state of being inserted into the embedding hole of the key, the weight main body can be stably attached without shifting in the length direction of the hollow member.

### BRIEF DESCRIPTION OF DRAWINGS

FIGS. 1A to 1C are views for explaining a keyboard weight according to a first embodiment of the present invention, in which FIG. 1A is a perspective view illustrating an appearance of the keyboard weight, FIG. 1B is a cross-sectional view of the keyboard weight cut along a length direction, and FIG. 1C is a perspective view illustrating a weight main body and a hollow member forming the keyboard weight in a separated state;

FIG. 2 is a perspective view illustrating an appearance of a key to which the keyboard weight of FIG. 1A is attached;

FIG. 3 is a view for explaining a method of attaching the keyboard weight to the key, and is an explanatory view of a weight component preparation step and a key preparation step;

FIG. 4 is a view following FIG. 3, and is an explanatory view of a keyboard weight manufacturing step;

FIGS. 5A and 5B are views following FIG. 4, which are explanatory views of a keyboard weight insertion step and a keyboard weight attachment step, in which FIG. 5A is a perspective view illustrating the keyboard weight inserted into an embedding hole and a periphery thereof, and FIG. 5B is a cross-sectional view of the keyboard weight cut along a length direction;

FIGS. 6A and 6B are views following FIGS. 5A and 5B, which are views illustrating a state in which the keyboard weight is attached to the key, in which FIG. 6A is a perspective view illustrating the keyboard weight and a periphery thereof, and FIG. 6B is a cross-sectional view of the keyboard weight cut along a length direction;

FIGS. 7A and 7B are views for explaining a keyboard weight according to a second embodiment of the present invention, in which FIG. 7A is a perspective view illustrating an appearance of the keyboard weight, and FIG. 7B is a cross-sectional view of the keyboard weight cut along a length direction;

FIG. 8 is an explanatory view for explaining a method of manufacturing the keyboard weight according to the second embodiment illustrated in FIG. 7A;

FIG. 9 is a view for explaining a method of attaching the keyboard weight according to the second embodiment, and is an explanatory view of a weight component preparation step and a key preparation step;

FIGS. 10A and 10B are views following FIG. 9, which are explanatory views of a keyboard weight manufacturing step, in which FIG. 10A is a perspective view illustrating a state in which a weight main body is inserted into a hollow member, and FIG. 10B is a perspective view illustrating a state in which a plurality of locking portions are formed at both end portions of the hollow member, respectively;

FIG. 11 is a view following FIGS. 10A and 10B, and is an explanatory view of a keyboard weight insertion step and a keyboard weight attachment step; and

FIG. 12 is a view following FIG. 11, and is a view illustrating a state in which the keyboard weight is attached to the key.

### DETAILED DESCRIPTION

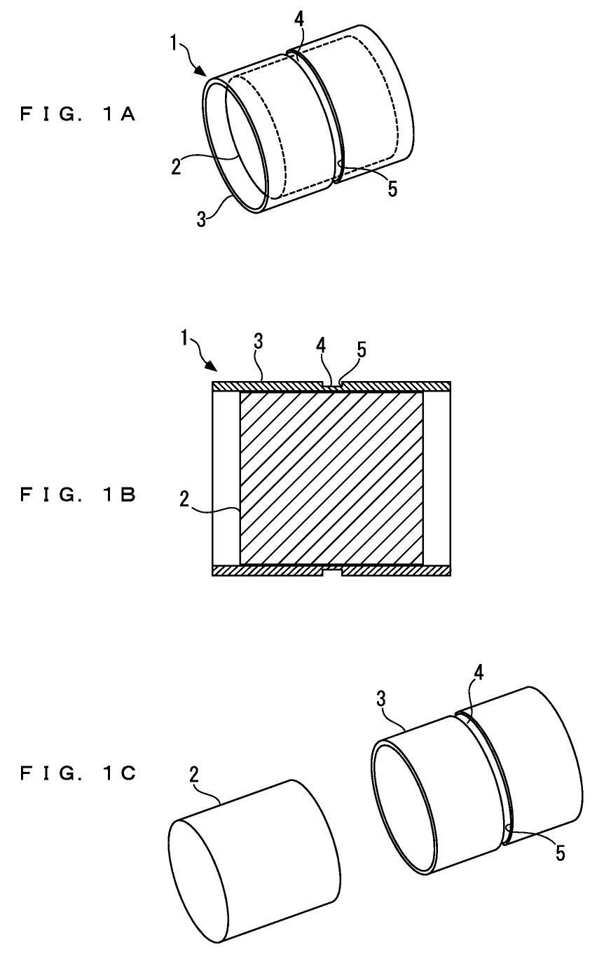

Hereinafter, preferred embodiments of the present invention will be described in detail with reference to the drawings. FIGS. 1A to 1C are views for explaining a keyboard weight according to a first embodiment of the present invention, in which FIG. 1A is an external perspective view of the keyboard weight, FIG. 1B is a cross-sectional view of the keyboard weight, and FIG. 1C is a perspective view illustrating a weight main body and a hollow member forming the keyboard weight in a separated state. As illustrated in these drawings, a keyboard weight 1 is a weight attached to a key of a keyboard device such as a grand piano, and is made of a material having a relatively high specific gravity other than lead, for example, a metal such as copper or brass.

The keyboard weight 1 includes a weight main body 2 formed in a columnar shape having a predetermined size, and a hollow member 3 formed in a cylindrical shape having a predetermined size capable of accommodating the weight main body 2 therein.

Specifically, the weight main body 2 is formed in a columnar shape having a predetermined diameter (for example, 12 mm) and a predetermined length (for example, 10 mm).

On the other hand, the hollow member 3 has a predetermined outer diameter (for example, 14 mm), a predetermined thickness (for example, 0.8 mm), and a predetermined length (for example, 14 mm), and is formed in a cylindrical shape slightly longer than the weight main body 2. In addition, the hollow member 3 is provided with a thin portion 4 extending over an entire circumferential direction and thinner than other portions at the center in a length direction. Specifically, the thin portion 4 has a predetermined thickness (for example, 0.2 mm) and a predetermined width (for example, 0.5 to 1.0 mm). The thin portion 4 is formed by providing, by cutting or the like, a groove 5 opened radially outward with respect to a metal cylindrical member before the thin portion 4 is provided.

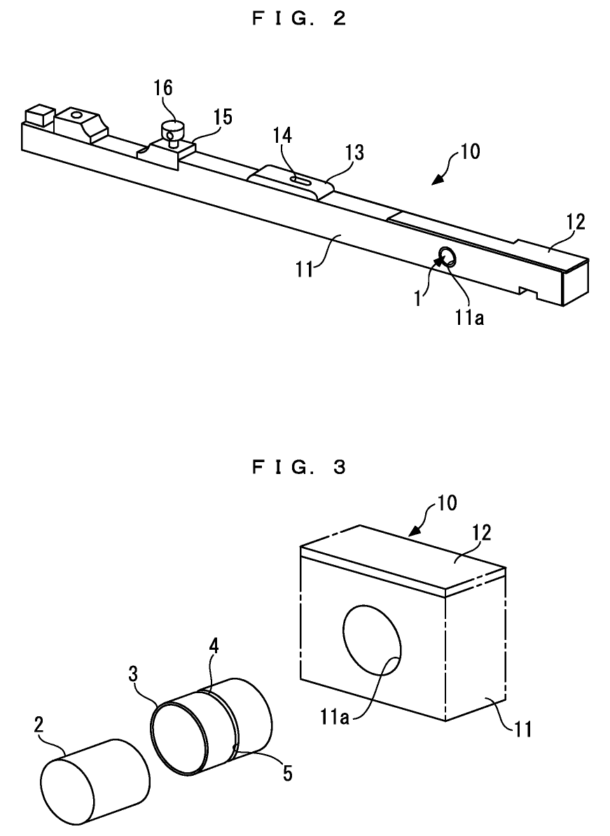

FIG. 2 illustrates a key (white key) 10 to which the keyboard weight 1 is attached. As illustrated in FIG. 2, the key 10 includes a key main body 11 extending in a front-rear direction, a white key cover 12 attached to a front portion of the key main body 11, and the keyboard weight 1 attached to a predetermined position of the front portion of the key main body 11.

The key main body 11 is made of relatively light, tough, and elastic wood such as spruce, has a rectangular cross section, and extends in the front-rear direction. The white key cover 12 is formed of plastic such as acrylic in an L shape, and is bonded to a front half portion of an upper surface and a front surface of the key main body 11 so as to cover them. A middle seat plate 13 is bonded to a center portion of the upper surface of the key main body 11, and a balance pin hole 14 is formed so as to penetrate them in an up-down direction. The key 10 is swingably supported by the balance pin hole 14 engaging with a balance pin (not illustrated) provided upright.

Further, a capstan screw 16 is attached to the upper surface of the key main body 11 at a position behind the balance pin hole 14 with a capstan seat plate 15 interposed therebetween, and actions (none of which is illustrated) for transmitting the operation of the key 10 to a hammer for string striking are placed on the capstan screw 16.

Further, an embedding hole 11a penetrating the key main body 11 in a left-right direction is formed at a predetermined position of the front portion of the key main body 11. The keyboard weight 1 is attached to the key main body 11 by being caulked in a state of being inserted into the embedding hole 11a.

Next, a method of attaching the keyboard weight 1 to the key 10 will be described with reference to FIGS. 3 to 6B. First, as illustrated in FIG. 3, the above-described weight main body 2 and hollow member 3 are prepared (weight component preparation step), and the key 10 for attaching the keyboard weight 1 is prepared (key preparation step).

Specifically, the weight main body 2 is manufactured by cutting a long round bar made of copper or brass and having the same diameter (for example, 12 mm) as the weight main body 2 at the same length (for example, 10 mm) as the weight main body 2. On the other hand, the hollow member 3 is manufactured by cutting a long cylindrical tube made of copper or brass and having the same outer diameter (for example, 14 mm) and thickness (for example, 0.8 mm) as the hollow member 3 at the same length (for example, 14 mm) as the hollow member 3 and forming the groove 5 (for example, a depth of 0.6 mm and a width of 0.5 to 1.0 mm) in each cylindrical tube. As for the key 10, the embedding hole 11a (for example, a diameter of 14 mm) penetrating the key main body 11 in the left-right direction is formed at a predetermined position of the key main body 11.

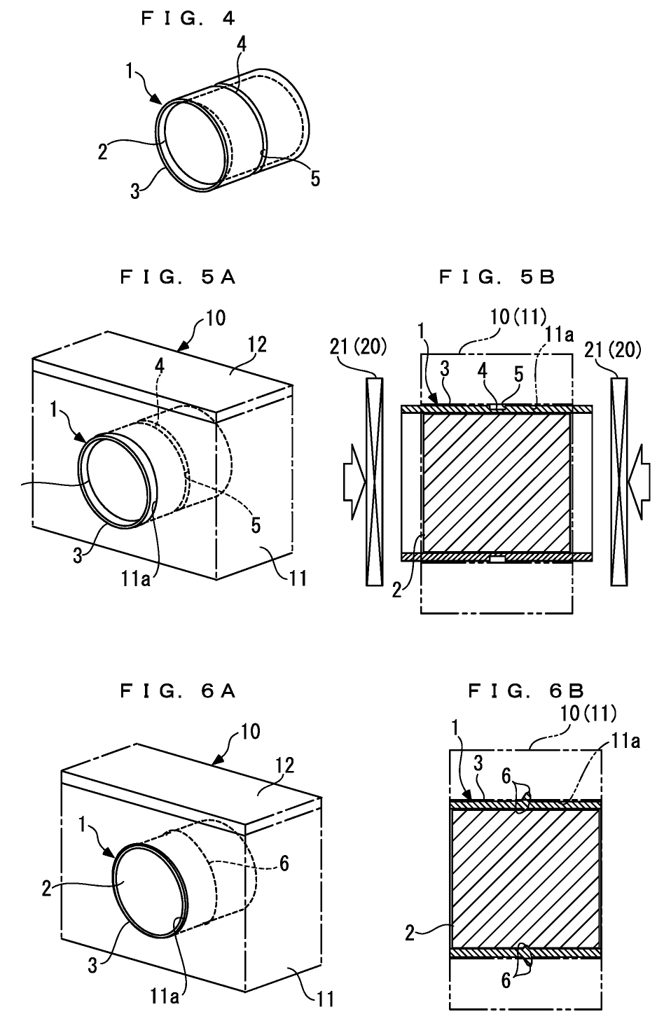

Next, as illustrated in FIG. 4, the keyboard weight 1 is manufactured by inserting the weight main body 2 into the hollow member 3 (keyboard weight manufacturing step). In this case, the weight main body 2 is inserted into the hollow member 3 such that the center thereof in the length direction is matched with the center of the hollow member 3. As a result, the entire weight main body 2 is accommodated in the hollow member 3, and both end portions of the hollow member 3 slightly protrude outward from an end surface of the weight main body 2.

Next, as illustrated in FIG. 5A, the keyboard weight 1 manufactured as described above is inserted into the embedding hole 11a of the key 10 (keyboard weight insertion step). In this case, the keyboard weight 1 is inserted into the embedding hole 11a such that both end portions of the hollow member 3 protrude outward from the embedding hole 11a by the same length.

Then, as illustrated in FIG. 5B, using a predetermined caulking machine 20 having two press portions 21 and 21 facing each other, the keyboard weight 1 inserted into the embedding hole 11a is pressed by both the press portions 21 and 21 from both left and right sides of the key 10 (keyboard weight attachment step). Specifically, both end portions of the hollow member 3 of the keyboard weight 1 are pressed from both sides. As the above-described caulking machine 20, a conventional caulking machine used when lead is attached to the embedding hole of the key can be used.

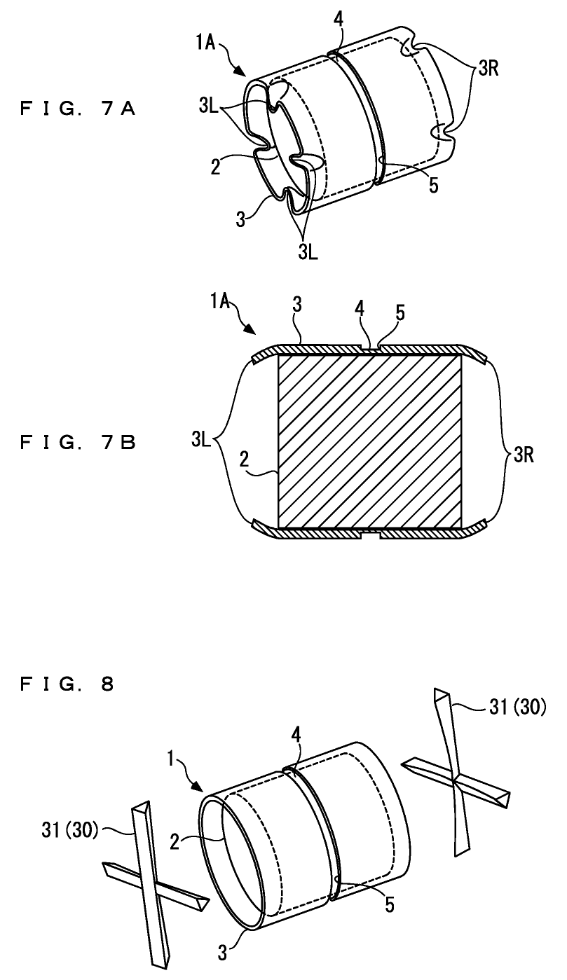

FIGS. 6A and 6B illustrate a state in which the keyboard weight 1 is attached to the key 10 by the pressing. In the keyboard weight 1 illustrated in FIG. 5B described above, when both end portions of the hollow member 3 are pressed, the hollow member 3 is buckled starting from the thin portion 4 which is more easily deformed than other portions of the hollow member 3. As a result, in the hollow member 3, as illustrated in FIG. 6B, a peripheral portion including the thin portion 4 is deformed inward and outward in the radial direction.

FIG. 6B illustrates an example of a state in which a peripheral portion including the thin portion 4 of the hollow member 3 (hereinafter, referred to as a “deformed portion 6”) is deformed. In FIG. 6B, the deformed portion 6 is deformed relatively largely outward in the radial direction to bite into a wall surface of the embedding hole 11a of the key main body 11, and is slightly deformed inward in the radial direction to slightly bite into the weight main body 2 or strongly press an outer peripheral surface of the weight main body 2. As a result, the keyboard weight 1 is firmly attached to the embedding hole 11a of the key main body 11. In a state where the keyboard weight 1 is attached to the key 10, both end surfaces of the hollow member 3 are substantially flush with the left and right side surfaces of the key main body 11.

As described in detail above, according to the present embodiment, it is possible to easily manufacture the keyboard weight 1 and to easily attach the keyboard weight 1 to the key 10 while using an alternative material instead of lead. In addition, the key 10 to which the keyboard weight 1 is firmly attached can be obtained.

Next, a keyboard weight according to a second embodiment of the present invention will be described with reference to FIGS. 7A and 7B. In the following description, components similar to those of a keyboard weight 1 of the first embodiment described above are denoted by the same reference numerals, and the description thereof will be omitted.

A keyboard weight 1A of the present embodiment is different from the keyboard weight 1 of the first embodiment described above only in that a weight main body 2 inserted inside is caulked by both end portions of a hollow member 3. That is, as illustrated in FIGS. 7A and 7B, in the keyboard weight 1A, a plurality of locking portions 3L and 3R for locking the weight main body 2 immovably in the length direction of the hollow member 3 are provided at both end portions of the hollow member 3. Specifically, four locking portions 3L arranged at equal angles to each other along the circumferential direction of the hollow member 3 are provided at one end portion (the left end portion in FIGS. 7A and 7B) of the hollow member 3 of the keyboard weight 1A. In addition, locking portions 3R similar to the above-described locking portions 3L are provided at the other end portion (the right end portion in FIGS. 7A and 7B) of the hollow member 3 of the keyboard weight 1A.

Each of the locking portions 3R and 3L is formed to protrude inward in the radial direction at the end portion of the hollow member 3. These locking portions 3R and 3L are formed by pressing the hollow member 3 from both sides by a caulking machine 30 having cross-shaped press portions 31 as illustrated in FIG. 8, for example.

Next, a method of attaching the keyboard weight 1A to the key 10 will be described with reference to FIGS. 9 to 12. First, as illustrated in FIG. 9, similarly to the method of attaching the keyboard weight 1 described above, the weight main body 2 and the hollow member 3 are prepared (weight component preparation step), and the key 10 for attaching the keyboard weight 1A is prepared (key preparation step).

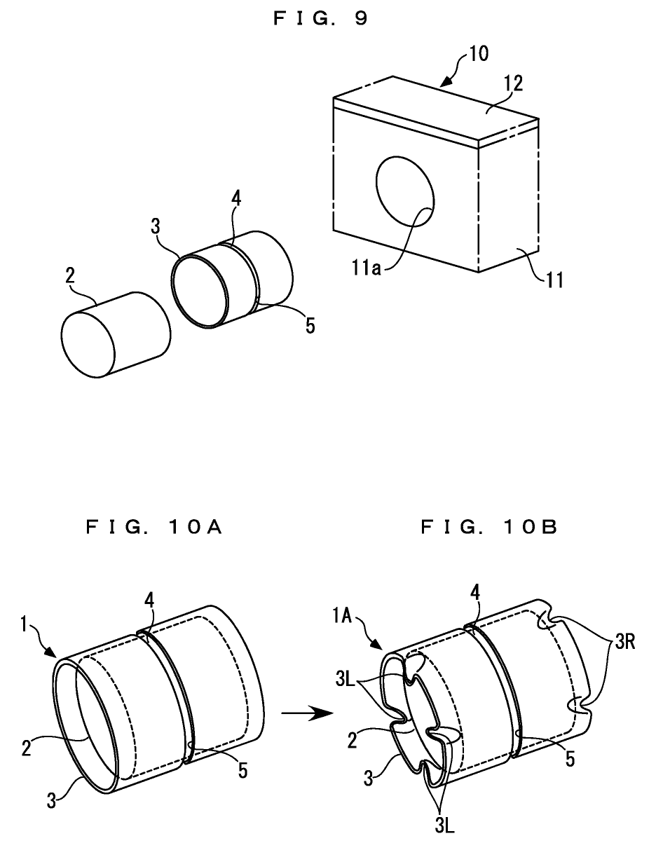

Next, as illustrated in FIG. 10A, the weight main body 2 is inserted into the hollow member 3 to manufacture the keyboard weight 1. Then, by pressing the hollow member 3 of the keyboard weight 1 from both sides using the above-described caulking machine 30 in FIG. 8, the keyboard weight 1A illustrated in FIG. 10B, that is, the keyboard weight 1A having the plurality of locking portions 3L and 3R at both end portions of the hollow member 3 is manufactured (keyboard weight manufacturing step).

Next, as illustrated in FIG. 11, the keyboard weight 1A manufactured as described above is inserted into the embedding hole 11a of the key 10 (keyboard weight insertion step). Then, using the above-described caulking machine 20, the keyboard weight 1A inserted into the embedding hole 11a is pressed by both the press portions 21 and 21 from both the left and right sides of the key 10 (keyboard weight attachment step).

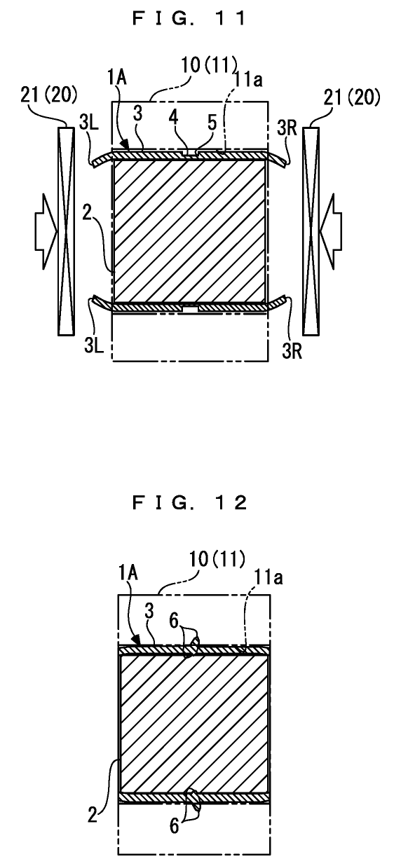

FIG. 12 is a view similar to FIG. 6B described above, and illustrates a state in which the keyboard weight 1A is attached to the key 10 by the pressing. In this method of attaching the keyboard weight 1A, buckling occurs starting from the thin portion 4 due to the pressing, similarly to the case of attaching the keyboard weight 1 described above, and in the hollow member 3, a peripheral portion (deformed portion 6) including the thin portion 4 is deformed inward and outward in the radial direction.

That is, as illustrated in FIG. 12, the deformed portion 6 of the hollow member 3 is deformed relatively largely outward in the radial direction to bite into the key main body 11, and is slightly deformed inward in the radial direction to slightly bite into the weight main body 2 or strongly press the outer peripheral surface of the weight main body 2. As a result, the keyboard weight 1A is firmly attached to the embedding hole 11a of the key main body 11. In a state where the keyboard weight 1A is attached to the key 10, both end surfaces of the hollow member 3 are substantially flush with the left and right side surfaces of the key main body 11, similarly to the keyboard weight 1 of the first embodiment described above.

As described above, according to the keyboard weight 1A of the present embodiment, it is possible to obtain effects similar to those of the keyboard weight 1 of the first embodiment described above. In addition, in the keyboard weight 1A, the weight main body 2 is immovably locked in the length direction of the hollow member 3 by the plurality of locking portions 3L and 3R provided at both end portions of the hollow member 3. Therefore, when the keyboard weight 1A is pressed and attached from both sides in the length direction of the hollow member 3 in a state of being inserted into the embedding hole 11a of the key 10, the weight main body 2 can be stably attached without shifting in the length direction of the hollow member 3.

Note that the present invention is not limited to the above-described embodiments, and can be implemented in various aspects. For example, copper and brass have been exemplified as constituent materials of the weight main body 2 and the hollow member 3 of the keyboard weights 1 and 1A, but the present invention is not limited thereto, and it is also possible to adopt other materials other than lead, for example, a metal or a synthetic resin having a relatively high specific gravity other than lead, and a composite material of such a metal and a synthetic resin. For example, when a synthetic resin (for example, polypropylene) having a relatively low elastic modulus is employed as the hollow member 3, or when the hollow member 3 made of a synthetic resin is employed, the locking portions 3L and 3R may be provided at both end portions of the hollow member 3 by pressing both end portions while applying heat to both end portions.

Further, the detailed configurations of the keyboard weights 1 and 1A, the weight main body 2, and the hollow member 3 described in the embodiments are merely examples, and can be appropriately changed within the scope of the gist of the present invention.

What is claimed is:

1. A keyboard weight immovably attached in an inserted state to a penetrating embedding hole having a predetermined diameter formed in a key of a keyboard instrument, the keyboard weight comprising:
a weight main body that is made of a material other than lead and is formed in a columnar shape having a predetermined diameter and a predetermined length; and
a hollow member that is made of a material other than lead, is formed in a cylindrical shape having an inner diameter allowing the weight main body to be inserted into the hollow member, an outer diameter allowing the hollow member to be inserted into the embedding hole, and a predetermined length longer than the weight main body, and is inserted into the embedding hole in a state where the weight main body is inserted inside when the keyboard weight is attached to the key, wherein
the hollow member is provided with a thin portion that extends along an entire circumferential direction, has a predetermined width in a length direction, and has a predetermined thickness smaller than a thickness of the other portion of the hollow member, and
the hollow member is configured such that when the keyboard weight is attached to the key, the hollow member is pressed from both sides in the length direction, whereby buckling occurs starting from the thin portion.

2. The keyboard weight according to claim 1, wherein the thin portion is formed by providing a groove that is located at a center in a length direction of the hollow member and is opened outward in a radial direction.

3. The keyboard weight according to claim 2, wherein both end portions of the hollow member into which the weight main body is inserted are provided with locking portions that are formed so as to protrude inward in the radial direction and lock the weight main body immovably in the length direction of the hollow member.

4. A key comprising:
a key main body that is made of wood, extends in a front-rear direction, and is configured to be swingable, the key main body being provided with an embedding hole penetrating the key main body in a left-right direction at a predetermined position in the front-rear direction; and
a keyboard weight that is attached by being pressed from both left and right sides of the key main body in a state of being inserted into the embedding hole of the key main body, wherein
the keyboard weight includes the keyboard weight according to claim 1.

5. A method of attaching a keyboard weight, comprising:
a weight component preparation step of preparing the weight main body and the hollow member according to claim 1;
a key preparation step of preparing a key provided with the embedding hole according to claim 1;
a keyboard weight manufacturing step of manufacturing the keyboard weight by inserting the weight main body into the hollow member;
a keyboard weight insertion step of inserting the manufactured keyboard weight into the embedding hole of the key; and
a keyboard weight attachment step of attaching the keyboard weight in a state of being fixed to the embedding hole of the key by causing buckling starting from
the thin portion by pressing the keyboard weight from both sides in a length direction.

6. The method according to claim 5, wherein in the keyboard weight manufacturing step, both end portions of the hollow member are pressed from both sides in a state where the weight main body is inserted into the hollow member to deform so as to protrude inward in a radial direction, and locking portions for locking the weight main body immovably in the length direction of the hollow member are formed.
